(19) United States
(12) Patent Application Publication
(10) Pub. No.: US 2005/0058869 A1
(43) Pub. Date: Mar. 17, 2005

(54) Low cost gas diffusion media for use in PEM fuel cells

(76) Inventors: Mark F. Mathias, Pittsford, NY (US); Joerg Roth, Trebur (DE); Michael R. Schoeneweiss, W. Henrietta, NY (US); Gerald J. Fleming, Andover, MA (US)

Correspondence Address: HARNESS, DICKEY & PIERCE, P.L.C., P.O. BOX 828, BLOOMFIELD HILLS, MI, 48303, US

(21) Appl. No.: 10/663,284

(22) Filed: Sep. 16, 2003

(51) Int. Cl. H01M 4/88; H01M 4/94; H01M 4/96

(52) U.S. Cl. 429/30; 502/101; 429/44

(57) ABSTRACT

A gas diffusion media and method of making are provided including the formation of a carbon fiber paper which is heated to a carbonization temperature without exceeding a graphitization temperature. The discovery that a final high temperature heat treatment step in the graphitization temperature zone is not necessary to make effective gas diffusion media for PEM fuel cells greatly reduces the cost associated with the high temperature final heat treatment and also allows for the processing of the diffusion media in a roll.

### FIELD OF THE INVENTION

The present invention relates to fuel cells and more particularly, to a low cost gas diffusion media for use in a PEM fuel cell.

### BACKGROUND AND SUMMARY OF THE INVENTION

Fuel cells have been used as a power source in many applications. For example, fuel cells have been proposed for use in electrical vehicular power plants to replace internal combustion engines. In proton exchange membrane (PEM) type fuel cells as well as in other fuel cell types, hydrogen is supplied to the anode of the fuel cell and oxygen is supplied as the oxidant to the cathode. A typical PEM fuel cell and its membrane electrode assembly (MEA) are described in U.S. Pat. Nos. 5,272,017 and 5,316,871, issued Dec. 21, 1993 and May 31, 1994, respectively, and assigned to General Motors Corporation. PEM fuel cells include a membrane electrode assembly (MEA) comprising a thin, proton transmissive, non-electrically conductive solid polymer electrolyte membrane having the anode catalyst on one of its faces and the cathode catalyst on the opposite face. PEM fuel cells usually employ bipolar plates with channels on either side for the distribution of reactants over the electrode area surfaces. Gas diffusion media (also known as gas diffusers or gas-diffusion backings) are provided between each face of the catalyst-coated proton exchange membrane and the bipolar plates. The region between reactant channels consist of lands, also known as ribs. Accordingly, in this type of design, roughly half of the electrode area is adjacent to the ribs and half is adjacent to the lands. The role of the gas diffusion media is to transition the anode and cathode gases from the channel-rib structure of the flow field to the active area of the electrode with minimal voltage loss. Although all of the current passes through the lands, effective diffusion media promote a uniform current distribution at the adjacent catalyst layers.

The gas diffusion media provide reactant gas access from the flow field channel to the catalyst layers, provide a passage for removal of product water from the catalyst layer area to the flow field channels, provide electronic conductivity from the catalyst layers to the bipolar plates, provide for efficient heat removal from the MEA to the bipolar plates where coolant channels are located and provide mechanical support to the MEA in case of large reactant pressure drop between the anode and cathode gas channels. The above functions impose electrical and thermal conductivity requirements on the diffusion media including both the bulk properties and the interfacial conductivities with the bipolar plates and the catalyst layers. Due to the channel-rib structure of the bipolar plates, the gas diffusion media also allow gas access laterally from the channels to the catalyst area adjacent to the lands to allow for electrochemical reaction there. The gas diffusion media also promote water removal laterally from the catalyst area adjacent to the land out to the channel. The gas diffusion media also provides electronic conductivity laterally between the bipolar plate land and the catalyst layer adjacent to the channel, and maintains good contact with the catalyst layer for electrical and thermal-conductivity and must not compress into the channels resulting in blocked flow and high channel pressure drops.

State-of-the-art diffusion media in proton-exchange-membrane (PEM) fuel cells consist of carbon fiber mats, often called carbon fiber paper. These papers use precursor fibers made typically from polyacrylonitrile, cellulous, and other polymeric materials. The processing consists of forming the mat, adding a resin binder, curing the resin with the material under pressure (i.e., molding), and progressively heating the material under inert atmosphere or vacuum to remove non-carbonaceous material. The final step in making the material is a high temperature heat treatment step that approaches or exceeds 2,000° C. reaching as high as 2,800° C. in some cases. This step is done in an inert gas (nitrogen or argon) or a vacuum environment, and the purpose is to remove noncarbonaceous material and convert the carbon into graphite. In part due to the high temperature and the brittleness of the material, this step is done in batch furnaces using stacks of square sheets of carbon fiber paper, usually one meter square. Converting the carbon to graphite results in superior electrical conductivity that has typically been understood to be necessary for use in PEM fuel cells. Carbon fiber papers are also used as gas diffusion electrodes in phosphoric acid fuel cell (PAFC) applications. In that application, the material must be graphitized in order to have sufficient corrosion resistance to withstand the hot phosphoric acid electrolyte. The cost of heat treating the carbon fiber papers to temperatures up to or exceeding 2000° C. is generally the most costly processing step in the entire sequence of producing the carbon fiber paper. Thus, it is desirable to make a less expensive gas diffusion media without sacrificing performance. Accordingly, the present invention provides a carbon fiber paper for use as a gas diffusion media that uses a final high temperature heat treatment process that achieves carbonization but not graphitization in order to provide a less expensive gas diffusion media for use in PEM fuel cells.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of the processing steps for producing the low cost gas diffusion media according to the principles of the present invention;

FIG. 2 is a schematic cross-sectional view of a membrane electrode assembly of a PEM fuel cell utilizing the diffusion media of the present invention;

FIG. 3 is a graphical illustration of the polarization curves of the gas diffusion media treated to different temperatures from a 50 cm² fuel cell;

FIG. 4 is a graphical illustration of the fuel cell voltage for gas diffusion media heat-treated to different temperatures for different current density values and obtained in a fuel cell stack; and

FIG. 5 is a table showing the d-spacing values and respective degree of graphitization for various diffusion media samples heated at different temperature levels.

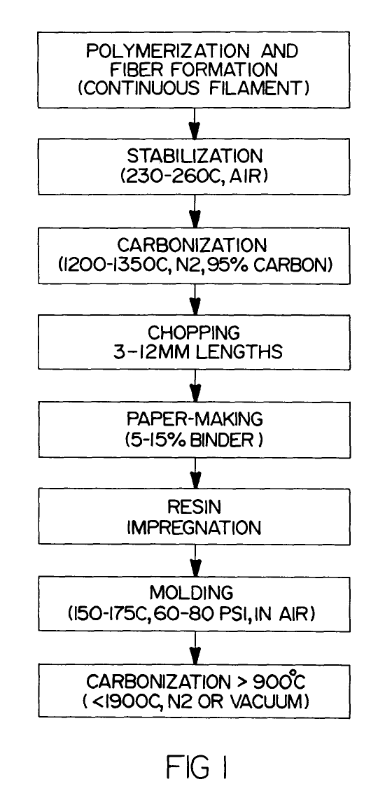

### DETAILED DESCRIPTION OF THE PREFERRED EMBODIMENTS

The following description of the preferred embodiment(s) is merely exemplary in nature and is in no way intended to limit the invention, its application, or uses.

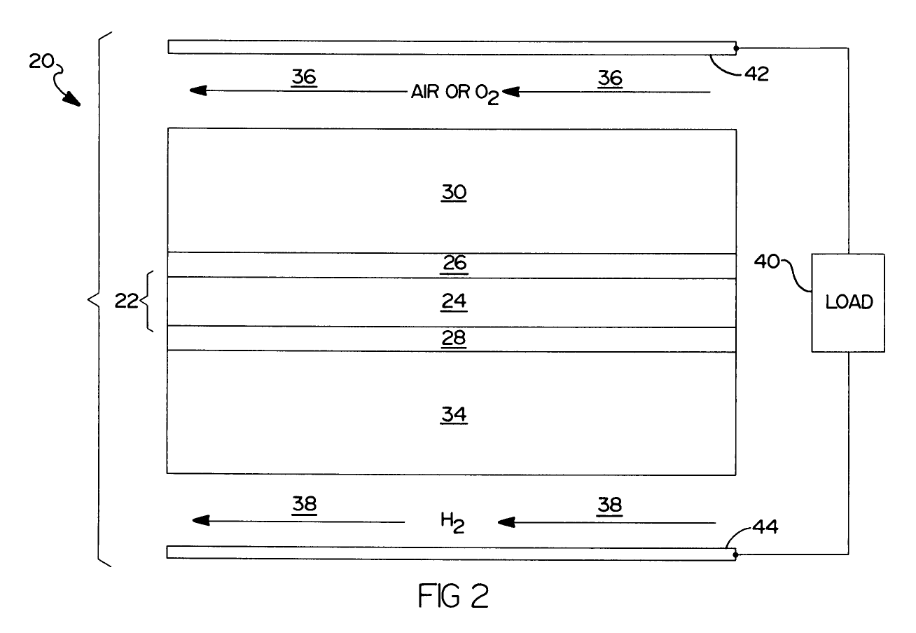

Referring to FIG. 2, a cross-section of a PEM fuel cell assembly 20 that includes a membrane electrode assembly (MEA) 22 is shown. The membrane electrode assembly 22 includes a membrane 24, a cathode catalyst layer 26, and an anode catalyst layer 28. Preferably, the membrane 24 is a proton exchange membrane (PEM). The membrane 24 is sandwiched between the cathode catalyst layer 26 and the anode catalyst layer 28. A cathode diffusion medium 30 is layered adjacent to the cathode catalyst layer 26 opposite the membrane 24. An anode diffusion medium 34 is layered adjacent to the anode catalyst layer 28 opposite the membrane 24. The fuel cell assembly 20 further includes a cathode flow channel 36 and an anode flow channel 38. The cathode flow channel 36 receives and directs oxygen (O₂) or air. The anode flow channel 38 receives and directs hydrogen (H₂) from a source. In the fuel cell assembly 20, the membrane 24 is a cation permeable, proton conductive membrane having H⁺ ions as the mobile ion. The fuel is hydrogen (H₂) and the oxidant is oxygen (O₂) or air. Since hydrogen is used as the fuel, the product of the overall cell reaction is water (H₂O). Typically, the water that is produced is rejected at the cathode 26 which is a porous electrode including an electrocatalyst layer on the oxygen side. The water may be collected as it is formed and carried away from the MEA of the fuel cell assembly 20 in any conventional manner.

The cell reaction produces a proton exchange in a direction from the anode diffusion medium 34 towards the cathode diffusion medium 30. The electrons flow from the anode catalyst layer, through the load, and back to the cathode catalyst layer. In this manner, the fuel cell assembly 20 produces electricity. An electrical load 40 is electrically connected across the MEA 22 by a first plate 42 and second plate 44 to receive the electricity. The plates 42 and/or 44 are bipolar plates if a fuel cell is adjacent to respective plate 42 or 44 or an end plate if a fuel cell is not adjacent thereto.

The gas diffusion media 30, 34, according to the principles of the present invention, are produced according to the following process. Initially, prior to paper formation, carbon fibers are formed (typically from polyacrylonitrile fiber precursor) and heated to a carbonizing temperature such as, for example, 1200-1350° C. in an inert gas such as nitrogen or argon. This process causes the carbon fibers to lose 50 percent of their weight while carbonizing the fibers to approximately 95 percent carbon content. The resultant fibers can have a tensile strength of greater than 400,000 psi. In addition, the carbon fibers have 32 million psi tensile modulus and densities ranging from 1.75-1.90 g/cc with fiber diameters of approximately 7 microns. The carbon fiber yarns or tows are then chopped into predetermined lengths, such as, for example, 3-12 mm lengths or any other length sufficient for a paper making process.

The paper making process is performed using the chopped predetermined length carbon fibers being dispersed in water with binders (typically polyvinyl alcohol) with the dispersion of fiber being as low as 0.01 percent by weight. The dispersion is dropped onto a porous drum or wire screen with a vacuum dryer to remove the water. The web is then dried in an oven or on heated drums. The web is then rolled up into rolls. The web typically has a 5-15 percent binder content by weight with the typical area weight being 45-70 gm/m² with a paper thickness of 0.2-0.27 mm. The paper web is then impregnated with a carbonizible thermoset resin. A phenolic resin is typically used although other resins may be utilized. The impregnated paper is then heated to approximately 125° C. for solvent evaporation and resin oligimerization (called B-staging).

The impregnated carbon fiber paper is then compression molded and fully cured by exposing the carbon fiber paper to temperatures up to 175° C. under a pressure of 60-80 psi for one hour. The impregnated carbon fiber paper is molded to a desired thickness and density. After molding, a post-cure is performed at approximately 200° C. in air for several hours to ensure full curing or cross linking (called C-staging) of the binder material. Finally, a heat treatment step is performed for carbonizing the molded paper by heating the paper to a carbonizing temperature. Typically, this temperature will range from between 900° C. and 1800° C., but other temperatures may be utilized depending upon specific materials used. The final heat treatment step is below the graphitization temperature for the carbon fiber paper. In other words, the graphitization temperature is typically greater than 1900° C.

Conventionally, the processing of diffusion media using carbon fiber paper was performed using a final heating step at a high temperature that approaches or exceeds 2000° C. reaching as high as 2800° C. in some cases. This step is performed in an inert gas (nitrogen or argon) or vacuum environment, and the purpose is to remove noncarbonaceous material and convert the carbon into graphite. The resulting diffusion media made, according to these conventional methods, have a carbon content greater than 99.5 weight percent.

It is a discovery of the present invention that the final high temperature heat treatment step (typically greater than 2000° C.) is not necessary to make diffusion materials for use in PEM fuel cells. In fact, a final heat treatment of as low as 950° C. can be sufficient to produce PEM gas diffusion media. The discovery of the sufficiency of this relatively lower heat treatment step greatly reduces the cost of diffusion media in that the high temperature heat treatment is the most costly processing step in the entire sequence of producing conventional carbon fiber paper sheets. This step is so costly because the furnace manufacturing and maintenance costs increase rapidly due to more severe furnace design, insulation material, and heater material requirements as the heat-treatment temperature increases from 1000° C. to 2800° C. Moreover, this finding enables the development of continuously processed diffusion media on a roll. Specifically, the lower temperature requirement makes it much more feasible to process a roll of diffusion media continuously without requiring batch processing for individual sheets. The resulting diffusion media made, according to the process of the present invention has a carbon content less than 99.5 weight percent. Using X-Ray diffraction, one can also characterize the degree of graphitization of carbon using a well defined and well-known quantity called the 002 d-spacing, d(002), which is a measure of the distance between the layer planes. K. Kinoshita, Carbon—Electrochemical and Physicochemical Properties John Wiley and Sons, NY, N.Y. (1988) p. 31. A sample with a d-spacing value of 3.354 Angstroms is considered to be fully graphitized and a sample with a d-spacing of 3.440 or higher is considered not to be graphitized at all. Samples with intermediate d-spacing are considered to be partially graphitized. In fact, the degree of graphitization, G, has been defined as:
G=[(d(002)−3.44)/(−0.086)]100%

### EXAMPLE 1

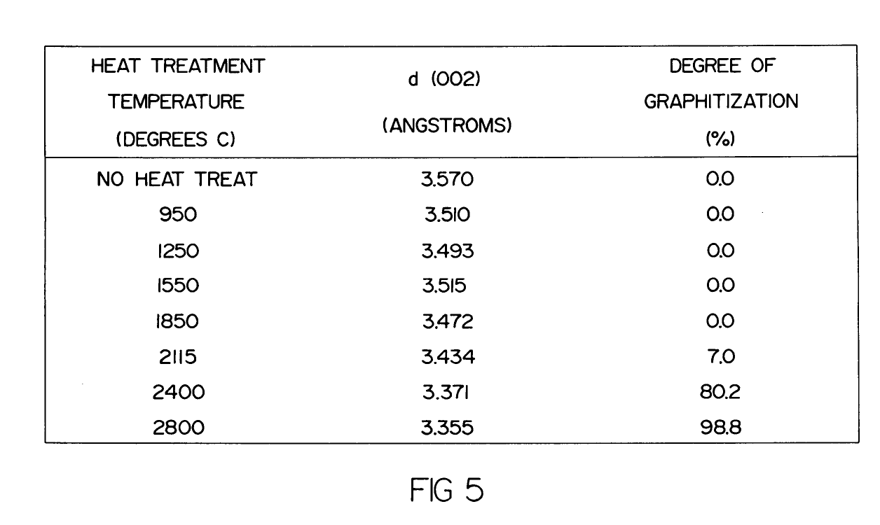

A series of carbon fiber paper samples were produced using the standard processing approach. The papers were wet-laid in continuous papermaking equipment and then impregnated with phenolic resin again in continuous equipment. The material was then cut into sheets and batch molded to a thickness of approximately 270 microns. Finally, these sheets were cut into small pieces and heat treated under argon to a variety of final temperatures from 950° C. to 2800° C. in a lab furnace. These finished materials were then characterized by X-Ray diffraction using standard techniques. Specifically, the samples were cut into 1″×1″ pieces and mounted on x-ray diffractometer (XRD) slides. XRD data was then collected using a Siemens D5000 diffractometer equipped with a copper x-ray tube and parallel beam optics. Copper k-alpha radiation was selected by using both a primary beam monochromator (Gobel Mirror) and a diffracted beam monochromator (LiF). Data were collected from 10 to 90 degrees 2 theta at 0.04 degrees/step and 4 seconds/step. D-spacings were calculated using the Bragg law and the 2 theta angle at the maximum observed intensity for graphene (002) reflection. The results are shown in the table provided in FIG. 5.

From the table in FIG. 5, one observes that the d-spacing values decrease as the heat treatment temperature is increased, indicating an increasing degree of graphitization. The degree of graphitization values in the table were calculated from the d-spacing values and the equation given above.

Example Test Data

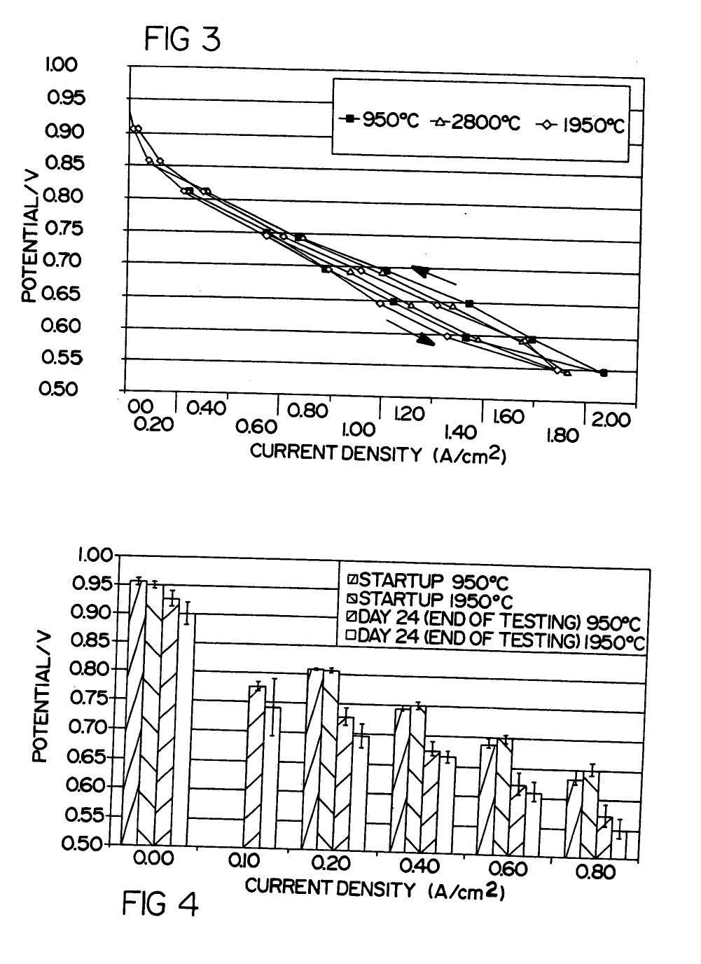

Example gas diffusion media made according to the process described above, one set of media being treated at 950° C. and the other being treated at 1950° C. as the final heat treatment step, were tested in a 50 cm² fuel cell and the data shows that the performance of the 950° C. treated material was equivalent to that of the 1950° C. treated diffusion media, as shown in FIG. 3. A third diffusion media, which was treated to approximately 2800° C. is also shown with the voltage being graphed on the y axis and the current density (A/cm²) being graphed on the x axis. As a further demonstration, the 950° C. and 1950° C. materials were also tested in a stack of thirteen cells with an 800 cm² active area. In FIG. 4, polarization results from the cells with the 950° C. material are shown to be equivalent, within experimental error, compared to those with the 1950° C. material. This was true both at the beginning of the life of the stack and on day 24 (after 450 hours of testing). This indicates that the beginning of life performance, as well as the durability performance of the two materials, are equivalent. Although the electrical conductivity of the 950° C. material is less than that of the partially graphitized material heated to 1950° C., the conductivity of the gas diffusion media heated to 950° C. was sufficient to maintain the performance of the cell. This is because the diffusion media bulk resistance, the primary quantity effected by the heat treatment temperature, is not a significant contributor to cell polarization losses. The d-spacing values of the samples that were tested were measured. The material heat treated to 1950° C. had a d-spacing of 3.398 Angstroms which corresponds with a 48% degree of graphitization. The sample treated to 950° C. and tested in the fuel cell had a d-spacing of 3.542 Angstroms, corresponding with a 0% degree of graphitization.

Note the 48% degree of graphitization of the 1950° C. sample is higher than one might expect from the data in the table shown in FIG. 5; the sample heat treated to higher temperature, 2115° C., only exhibited a 7% degree of graphitization. This is because the time that the sample spends at the maximum temperature also strongly impacts the degree of graphitization, and the 1950° C. sample was heat-treated in production equipment for a longer time than the 2115° C. sample that was treated in a laboratory furnace

With the discovery of the present invention, the cost of a diffusion media treated to approximately 900-1900° C. will be substantially less than that treated at conventional temperatures of 1900° C. or greater. In addition, this lowered heat treatment requirement allows the development of a continuously produced and rollable diffusion media that allows for further cost reduction and enables diffusion media manufacturing in large volume.

The description of the invention is merely exemplary in nature and, thus, variations that do not depart from the gist of the invention are intended to be within the scope of the invention. Such variations are not to be regarded as a departure from the spirit and scope of the invention.

1. A method of making a gas diffusion media for a fuel cell, comprising the steps of:
cutting carbon fibers into predetermined lengths;
forming a paper material using the chopped carbon fibers;
impregnating the paper material with a thermoset resin material;
molding the impregnated paper material to a predetermined thickness and density; and
heating the molded impregnated paper material to a carbonization temperature without heating to a graphitization temperature.

2. The method according to claim 1, wherein said carbonization temperature is between 900° C. and 1400° C.

3. The method according to claim 1, wherein said graphitization temperature is greater than 1900° C.

4. The method according to claim 1, wherein said molded impregnated paper material is a rolled web.

5. The method according to claim 1, wherein said gas diffusion media has a carbon content less than 99.5 weight percent.

6. The method of claim 1, wherein said gas diffusion media has a d-spacing (d(002)) of 3.44 Angstroms or higher.

7. A method of making a fuel cell, comprising the steps of:
processing a diffusion media by forming a paper material using cut carbon fibers; impregnating the paper material with a resin material; molding the impregnated paper material; and heating the molded impregnated paper material to a carbonization temperature without heating to a graphitization temperature;
placing a pair of diffusion media sheets on opposing sides of a proton-exchange-membrane; and
placing a bipolar plate on opposite sides of said diffusion media sheets from said proton-exchange-membrane.

8. The method according to claim 7, wherein said diffusion media has a carbon content less than 99.5 weight percent.

9. The method of claim 7, wherein said gas diffusion media has a d-spacing (d(002)) of 3.44 Angstroms or higher.

10. A fuel cell, comprising:
a proton exchange membrane having a cathode catalyst on one surface thereof and an anode catalyst on an opposite surface thereof;
a diffusion media sheet disposed on opposite sides of said proton exchange membrane, said diffusion media sheet having a carbon content less than 99.5 weight percent; and
a pair of bipolar plates on opposite sides of said diffusion media sheets from said proton exchange membrane.

11. A fuel cell, comprising:
a proton exchange membrane having a cathode catalyst on one surface thereof and an anode catalyst on an opposite surface thereof;
a diffusion media sheet disposed on opposite sides of said proton exchange membrane, said diffusion media sheet having a d-spacing of 3.440 or higher; and
a pair of bipolar plates on opposite sides of said diffusion media sheets from said proton exchange membrane.
